(19) United States
(12) Patent Application Publication
(10) Pub. No.: US 2003/0059138 A1
(43) Pub. Date: Mar. 27, 2003

(54) Assembly forming a seal with a bulit-in encoder

(75) Inventors: Rene Nantua, Sillingy (FR); Alain Bochet, Seynod (FR); Jean-Pierre Sand, Annecy (FR)

Correspondence Address: MICHAEL BEST & FRIEDRICH LLP, 3773 CORPORATE PARKWAY, SUITE 360, CENTER VALLEY, PA, 18034-8217, US

(73) Assignee: The Torrington Company, Torrington, CT

(21) Appl. No.: 09/963,259

(22) Filed: Sep. 25, 2001

(51) Int. Cl. F16C 32/00

(52) U.S. Cl. 384/448

(57) ABSTRACT

An assembly forming a seal with a built-in multi-pole magnetic encoder, intended to be mounted between a stationary support and a rotating support forming part of a rolling bearing. The assembly comprises a stationary armature secured to the stationary support and a moving armature bearing the encoder and secured to the rotating support. The assembly has no means allowing the association of a sensor past which the encoder moves. The magnetic encoder comprises a low even number of poles allowing the sensor to be distanced from the stationary armature such that magnetic flux of the encoder may be detected by the sensor that can electronically compensate for the reduction in the number of the pairs of poles, with detection being performed through the stationary armature.

### BACKGROUND OF THE INVENTION

This invention relates generally to rolling bearings equipped with a rotating means that generates pulses, known as an encoder, to be used with a detection device, known as a sensor, for obtaining information such as, for example, the speed of rotation. Such bearings may, for example, be used in motor vehicle wheels equipped with wheel anti-lock systems. The invention relates more particularly to rolling bearings with built-in magnetic encoders, the functionally associated sensor being of the magneto-resistor or Hall-effect probe type, for example.

Numerous designs of such rolling bearings with built-in magnetic encoder are already known in the prior art. Reference may, for example, be made to the following documents:

French Patent Applications: 2 667 947; 2 669 432; 2 669 728; 2 671 633; 2 678 691; 2 678 692; 2 690 989; 2 693 272; 2 694 082; 2 702 567; 2 710 985; 2 718 499:

European Patent Applications: 375 019; 420 040; 420 041; 438 624; 487 405; 488 853; 498 298; 518 157; 521 789; 522 933; 531 924; 557 931; 557 932; 647 851; 693 689; 701 132; 701 133; 714029; 745 857; 751 311; 753 679; 767 385. Reference may be made, also by way of example, to the following documents filed by the applicant company:

French Patent Applications: 2 639 689; 2 640 706; 2 645 924; 2 730 283; 2 732 458; 2 717 266; 2 701 298:

European Patent Applications: 371 836; 376 771; 484 195; 394 083; 607 719; 616 219; 619 438; 631 140; 652438; 671 628; 725 281; 735 348.

The very wide variety of designs proposed in the prior art for such rolling bearings with built-in magnetic encoders illustrates the fact that a number of technical problems posed by these rolling bearings have not yet found a satisfactory solution. This is the case, in particular, for the control over the geometric distance separating the encoder and the sensor is concerned. As the magnetic inductance delivered by the encoder varies greatly with the air gap, the information delivered by the sensor (which is safety information in the case of applications such as wheel anti-lock systems) may be corrupted if the encoder/sensor distance is not correctly controlled.

In this respect, a distinction can be made between two main types of functional associations of the sensor, with respect to the rolling bearing, in the designs of the prior art. The first type of functional association of the sensor with respect to the rolling bearing, hereinafter known by the term “first type of association” is very predominant. In this first type of association, means, possibly reversible, is provided for securing the sensor to the rolling bearing.

Documents EP-A-464 403, EP-A-464 404, EP-A-464 405 describe rolling bearings with functionally built-in passive sensors borne by a support built into the stationary ring of the rolling bearing. Document EP-A-596 873, filed by the applicant company, describes a rolling bearing or bearing with built-in encoder, in which the sensor is fixed radially to the rolling bearing. Document EP-A-495 323, filed by the applicant company, describes a rolling bearing with built-in encoder, in which an annular attachment collar allows the sensor and bearing to be associated, the collar having a diameter approximately equal to the outside diameter of a stationary part of the rolling bearing seal, this sensor being borne by the collar.

Document EP-A-371 836, filed by the applicant company, describes a rolling bearing with encoder and sensor arranged on supports mounted on the rings of the rolling bearing, one of the supports being continued by a fitting against which the sealing lips of the seal bear. Document EP-A-394 083, filed by the applicant company, describes a preassembled bearing comprising a magnetic encoder annulus backed up against a sensor, the encoder or the sensor being mounted on an elastically deformable mounting. Document EP-A-821 240 describes a rolling bearing comprising an encoder means and a sensor means, the sensor means being supported by a sensor bearing unit secured to the stationary ring of the rolling bearing, the bearing comprising a means for trapping the sensor bearing unit against a surface of the stationary ring.

For this first type of association, reference may also be made to the following documents: EP-A-822 413; EP-A-619 438; FR-A-2 717 266; FR-A-2 732 458; FR-A-2 730 283; EP-A-725 281; FR-A-2 740 186.

The second type of association of the sensor with respect to the rolling bearing, hereinafter known by the term “second type of association” is the one in which the sensor is not directly supported by the rolling bearing and is dissociated from the rolling bearing with built-in magnetic encoder. Reference may, for example, be made to document EP-A-607 719 filed by the applicant company.

Both the first type of association and the second type of association of the sensor with respect to the rolling bearing exhibit numerous drawbacks. In the first type of association, the fitting of the sensor on the rolling bearing may pose problems resulting from:

vibrations in service;

handling during the phases of assembling the rolling bearing on its support; and

differences in thermal expansion between the steel of the rolling bearing, the material of the seal and the sensor.

To solve these problems in particular, deformable positioning means have been envisaged. Reference may, for example, be made to the following documents: FR-A-2 752 447; WO A 97/15 833. The deformable positioning means set out hereinabove, just like the means for associating the sensor with the rolling bearing in the first type of association considered, has the substantial drawback of entailing modifications to the geometry of the rolling bearing, at least in the vicinity of the encoder, to allow the sensor to be fitted. A design such as this is therefore not at all modifiable, the rolling bearing, the means for associating the sensor and any deformable positioning means there might be having to be designed simultaneously.

The second type of association of the sensor with respect to the bearing, as described in document EP-A-607 719 filed by the applicant company, has the drawback of leaving the encoder bare and therefore unprotected from attack by the surroundings. In certain applications, this absence of protection may be detrimental to the correct operation of the encoder.

The harmful effect of certain environments on the operation of magnetic encoders is known to those skilled in the art. Document FR-A-2 642 483, filed by the applicant company, describes a rotary seal with built-in magnetic encoder in which the sealing lips isolate the air gap and separate the entire sensor with its encoder from the harmful agents arising from the exterior or the interior of the bearing.

Document EP-A-726 468 describes a rolling bearing with built-in encoder in which the encoder is fixed to an interior face of a rigid protective and support element made of a nonmagnetic metallic material, a corresponding exterior face of said protective element rotating past said sensor. The magnetic encoder borne by the rotary protective element described in EP-A-726 468 may attract the magnetic particles such as swarf and this may cause disturbances in the signal received by the sensor.

Document FR-A-2 755 193 describes a rolling bearing in which the pulse-generating part of the rolling bearing with built-in encoder is placed inside the sealing device, a nonmagnetic piece forming a cover being placed fixedly in front of the pulse-generating piece. In the design described in this document FR-A-2 755 193, it is mentioned that the protective wall and the sensor are advantageously in contact. Such contact is, in fact, disadvantageous, as the dimensional variations due to the thermal expansions or associated with in-service vibrations can lead to an alteration of this protective wall/sensor contact. The parasitic lateral displacements in operation of a rolling bearing equipped with such a sensor may lead to stresses being imposed on this sensor. In the design described in document FR-A-2 755 193, the contact between the protective wall and the sensor is all the more necessary when the diameter of the rolling bearing is small, the magnetic field delivered by the encoder built into a small-diameter rolling bearing being too weak for the sensor to be able to be placed a great distance away from the encoder.

The foregoing illustrates limitations known to exist in present devices and methods. Thus, it is apparent that it would be advantageous to provide an alternative directed to overcoming one or more of the limitations set forth above. Accordingly, a suitable alternative is provided including features more fully disclosed hereinafter.

### SUMMARY OF THE INVENTION

In one aspect of the invention, this is accomplished by providing an assembly forming a seal with a built-in multi-pole magnetic encoder, intended to be mounted between a stationary support and a rotating support forming part of a rolling bearing. The assembly comprises a stationary armature secured to a stationary support and a moving armature bearing the encoder and secured to the rotating support. The assembly is capable of having no means allowing the association of a sensor past which the encoder can move. The multi-pole magnetic encoder comprises a low even number of poles to allow an exterior lateral face of the stationary armature to be distanced from the sensor such that magnetic flux of the encoder may be detected by the sensor through the stationary armature.

The foregoing and other aspects will become apparent from the following detailed description of the invention when considered in conjunction with the accompanying drawing figures.

### BRIEF DESCRIPTION OF THE DRAWING FIGURES

FIG. 1 is a view in axial section of a seal with built-in magnetic encoder for a rolling bearing or bearing according to one embodiment of the invention;

FIG. 2 is a view similar to FIG. 1 of a second embodiment of the invention;

FIG. 3 is a diagram depicting the change in inductance as a function of air gap for an encoder with 48 pairs of poles and an encoder with 24 pairs of poles, in a given mechanical configuration;

FIG. 4 is a diagram similar to FIG. 3, on a half-log scale;

FIG. 5 is a diagram of a device for processing the signal emanating from the encoder and received by the sensor;

FIG. 6 is a diagram showing the signals emanating from the sensor and the signals that are obtained after processing; and

FIG. 7 is a diagram of a device for processing the signal emanating from the encoder and received by the sensor according to another embodiment.

### DETAILED DESCRIPTION

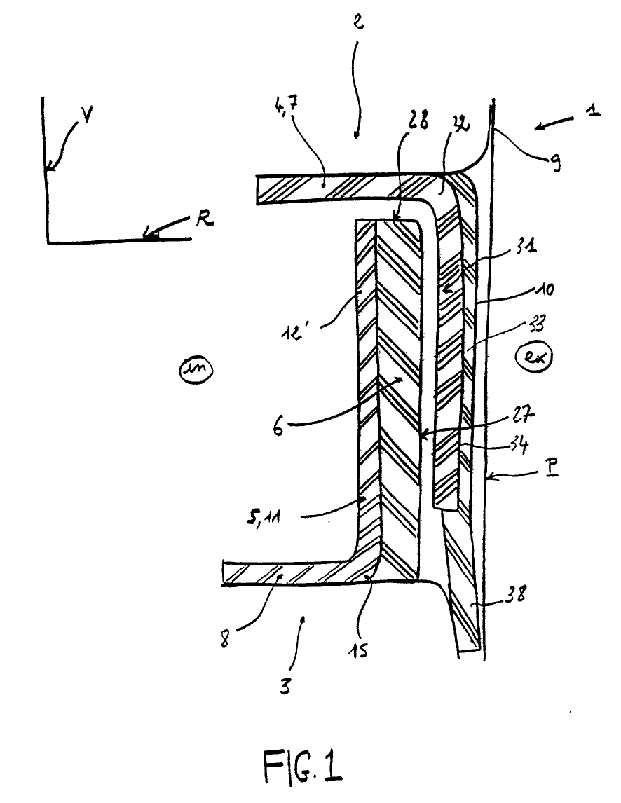

Referring now to the drawings, FIG. 1 is a detail view of a preassembled assembly 1 forming a seal with built-in encoder intended to be mounted between a stationary support 2 and a rotating support 3 forming part of a rolling bearing. When the preassembled assembly 1 is mounted in a rolling bearing, the stationary support 2 is the exterior ring of the rolling bearing and the rotating support 3 is the interior ring of the rolling bearing, in the configuration depicted.

A stationary armature 4 is secured to the stationary support 2. Likewise, a moving armature 5 comprising a multi-pole magnetic encoder disk 6 is secured to the rotating support 3. The person skilled in the art will understand that by switching the stationary armature 4 and the moving armature 5, the preassembled assembly 1 can be built into a rolling bearing which has a moving exterior ring and a stationary exterior ring.

In the embodiment depicted in FIG. 1, the moving armature 5 is shrink fitted onto the rotating support 3, via a first cylindrical bearing surface 8, so that the two parts are joined together. Likewise, the stationary armature 4 is shrink fitted onto the stationary support 2, via a second cylindrical bearing surface 7. In other embodiments, which have not been depicted, the stationary armature and/or the moving armature are clipped and/or bonded onto the stationary support and moving support respectively. In other embodiments, which are not depicted, the stationary armature is shrink fitted onto the exterior of the stationary support.

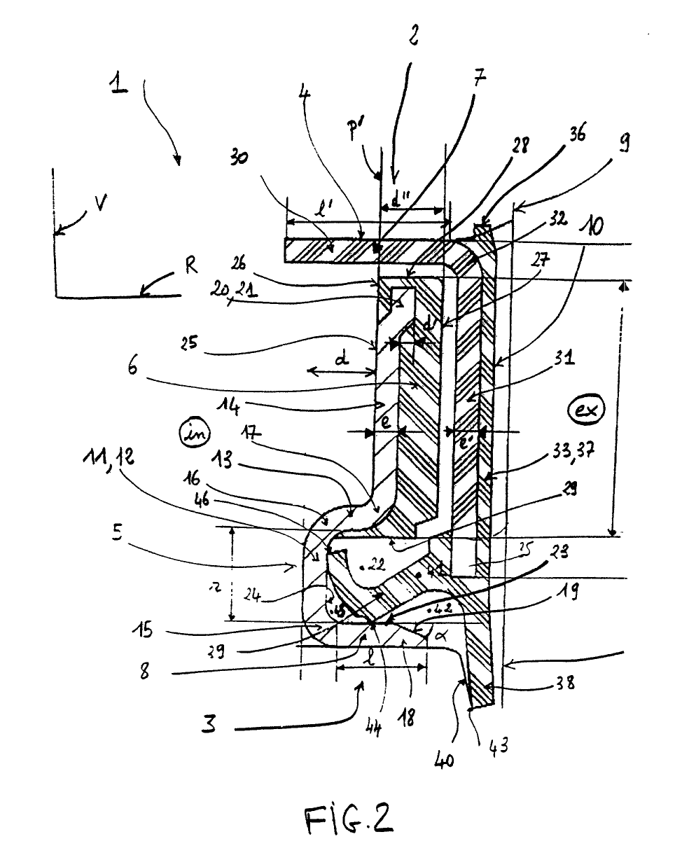

In what follows of this description, the terms “internal”, “interior”, “external”, “exterior” will be used with reference to the captions in and ex placed in FIGS. 1 and 2. Thus, when the preassembled assembly is intended to be built into a rolling bearing, the caption in placed to the left of the moving armature 5 in FIG. 1 corresponds to the interior of the bearing, containing the rolling bodies, the caption ex placed to the right of the stationary armature 4 in FIG. 1 corresponding to the space located beyond the plane P tangential to the exterior lateral face 9 of the stationary support 2.

The direction R is parallel to the axis of rotation of the rotating support 3. In the remainder of the text, for reasons of simplification, this direction R will be taken as being horizontal and the dimensions measured in this direction R will be said to be “axial”. The direction V perpendicular to the selection R defines, with the direction R, the plane of section of FIG. 1. This direction V is therefore taken as being vertical and the dimensions measured in this direction V will be said to be “radial”.

In the embodiment depicted in FIG. 1, the exterior lateral face 10 of the stationary armature 4 is offset and set back toward the interior with respect to the plane P defined hereinabove. In other embodiments, not depicted, the exterior lateral face of the stationary armature is tangential to said plane P without protruding toward the exterior with respect to this plane. In still other embodiments, not depicted, the exterior lateral face of the stationary armature projects toward the exterior slightly with respect to said plane P.

The moving armature 5 comprises, starting from the rotating support and working toward the stationary support 2, in the embodiment of FIG. 1:

the first cylindrical bearing surface 8 which is annular and axial;

an annular wall 12′ which is radial.

A connection fillet 15 connects the first cylindrical bearing surface 8 and the annular wall 12′. A multi-pole magnetic encoder disk 6 is overmolded onto the base part 11 of the moving armature 5. This disk may, for example, be made of elastomer filled with ferrite such as barium ferrite or strontium ferrite. In the embodiment depicted, the encoder disk 6 extends over the entire radial dimension of the wall 12′. In other embodiments, which have not been depicted, the encoder disk 6 extends over just part of the radial dimension of the wall 12′.

The exterior lateral face 27 of the encoder disk 6 is approximately vertical and separated from the stationary armature 4, which protects the encoder by an amount, which exceeds the functional clearances. The annular face 28 placed facing the cylindrical bearing surface 7 of the stationary armature 4 is likewise separated from this bearing surface to prevent any contact between the encoder 6 and this bearing surface as the encoder 6 rotates.

The stationary armature 4 comprises, starting from the stationary support 2 and working radially toward the rotating support 3:

the second cylindrical bearing surface 7; and

a radial annular wall 31 supporting a seal.

A connection fillet 32 connects the second cylindrical bearing surface 7, which is axial, and the seal support wall 31. In the embodiment depicted, an overmolded seal 33 covers the exterior lateral face 34 of the wall 31. In other embodiments, which have not been depicted, the seal 33 does not cover the wall 31 but merely comprises static sealing heel and a dynamic sealing lip. In yet other embodiments, not depicted, the sealing means does not cover the wall 31 but comprises at least one dynamic sealing means such as a lip.

In the embodiment depicted in FIG. 1, this seal 33 comprises a dynamic sealing lip 38 placed on the bearing, with interference, against the exterior lateral face of the rotating support 3. The internal piece 30 of the stationary armature is made of a nonmagnetic material, as is the seal 33, so that the stationary armature does not in any disturb the field lines emanating from the encoder 6.

Reference is now made to FIG. 2. Those elements, which are common to the embodiments of FIGS. 1 and 2, are referenced in the same way. The moving armature 5 as depicted in the embodiment of FIG. 2 is now described in fuller detail. The moving armature 5 comprises an annular base part 11 comprising, starting from the rotating support 3 and working radially toward the stationary support 2, in the embodiment depicted:

the first cylindrical bearing surface 8 which is annular and axial;

a first annular wall 12 which is radial;

a second annular wall 13 which is axial; and

a third annular wall 14 which is radial and offset by an axial distance d with respect to the annular first wall 12.

The first annular wall 12 and the third annular wall 14 are approximately mutually parallel and parallel to the plane P, in the embodiment depicted. The first cylindrical bearing surface 8 and the second annular wall 13 are approximately concentric and their lines in the plane of FIG. 2 are approximately parallel to the direction R. A first connection fillet 15 connects the first cylindrical bearing surface 8 and the first annular wall 12. A second connection fillet 16 connects the first annular wall 12, which is radial, to the second annular wall 13, which is axial. A third connection fillet 17 connects the second annular wall 13, which is axial, to the third annular wall 14, which is radial.

The first end part 18 of the base piece 11 comprises a chamfer 19 forming a cone frustum, of which the line, in the place of FIG. 1, is inclined by an angle a of between 5 and 30° approximately with respect to the horizontal. The second end part 20 of the base piece 11 comprises a cutout 21 toward the exterior forming a fourth annular wall which is radial, and offset toward the exterior by an axial distance d′ with respect to the third annular wall 14. In the embodiment depicted, the distance d′ is of the order of half the thickness e of the moving armature 5, the annular base piece 11 of the moving armature 5 having an approximately constant thickness e, except for the chamfered first end part 18.

The first cylindrical bearing surface 8, the first annular wall 12 and the second annular wall 13 form, with the connection fillets 15 and 16, an annular groove 22, the opening of which faces toward the exterior. In the embodiment depicted in FIG. 2, this annular groove 22 has, in the axial section plane being considered, a U-shaped profile, the maximum axial dimension of which is practically identical to its maximum radial dimension. In other words, in the embodiment depicted, the axial length 1 of the cylindrical bearing surface 8 is approximately equal to the radial dimension r of the first annular wall 12.

The exterior lateral face of the annular groove 22 comprises an axial annular surface 23 and a radial annular surface 24 which, as will become apparent hereinafter, form bearing surfaces for dynamic sealing means arranged on the stationary armature 4 of the assembly 1. The base piece 11 of the moving armature 5 may be made of a magnetic material such as X4Cr17 stainless steel, for example. A multi-pole magnetic encoder disk 6 is overmolded on the base piece 11 of the moving armature 5. This disk may, for example, be made of an elastomer filled with ferrite such as strontium ferrite or barium ferrite. Other fillers capable of producing high magnetic flux densities per unit volume may be theoretically envisaged, for example magnetic neodymium-iron-boron or samarium-cobalt alloys. However, ferrets are far less expensive and far easier to magnetize and are therefore usually preferred.

In the example depicted, the encoder disk 6 covers an entire lateral surface of the second 13, third 14 and fourth 21 lateral walls of the base piece 11 and coats the cutout 21 formed on the second end part 20 of this base piece 11. The annular interior lateral surface 25 of the third annular wall 14 is placed approximately in the continuation of the annular interior lateral surface 26 of the encoder 6, in a transverse plane P′ separated by an axial distance d″ from the exterior lateral face 27 of the encoder 6, so that the encoder disk 6 projects toward the exterior from the third annular wall 14 by an axial dimension of the order of twice the thickness e of the base piece 11.

The exterior lateral face 27 of the encoder disk 6 is approximately vertical and separated from the stationary armature 4 that protects the encoder by a value that exceeds the functional clearances so as to prevent any contact between the rotating encoder 6 and the stationary armature 4. The annular face 28 placed facing the cylindrical bearing surface 7 of the stationary armature 4 is likewise separated from this bearing surface 7 so as to prevent any contact between the encoder 6 and this bearing surface 7 as the encoder 6 rotates.

In the embodiment depicted, the encoder 6 is bounded radially by the annular face 28 and an annular face 29 that is approximately concentric with the face 28 and with the axial annular surface 23 of the first bearing surface 7. The annular face 29 is separated from the axial annular surface 23 by the amount r defined hereinabove. The maximum radial dimension r′ of the encoder 6, represented by the radial distance separating the annular faces 28, 29, is of the order of three times the value r defined hereinabove, in the embodiment being considered.

A fuller description of the stationary armature 4 is now given. The stationary armature 4 comprises an internal piece 30 comprising, starting from the stationary support 2 and working radially toward the rotating support:

the second cylindrical bearing surface 7; and

a radial annular seal support wall 31.

A connection fillet 32 connects the second cylindrical bearing surface 7, which is axial, and the seal support wall 31. The internal piece 30 of the stationary armature 4 has an approximately constant thickness e′. The internal piece 30 has, in the axial section depicted in FIGS. 1 and 2, a L-shaped profile with a maximum axial dimension shorter than its maximum radial dimension. In other words, in the embodiment depicted, the axial length 1′ of the second cylindrical bearing surface 7 is shorter than the radial dimension r″ of the seal support wall 31. This radial dimension r″ of the wall 31 exceeds the maximum radial dimension r′ of the encoder 6.

The internal piece 30 of the stationary armature may or may not be solid and is made of a nonmagnetic material such as a polymer or certain stainless steels, for example, so that the seal support wall 31 is perfectly magnetically transparent and does not in any way disturb the field lines emanating from the encoder 6. The seal support wall 31 is approximately parallel to the exterior lateral face 27 of the encoder and approximately to the planes P and P′ defined hereinabove. An overmolded seal 33 covers the exterior lateral face 34 of the wall 31 and coats the end part 35 of this wall.

In the embodiment depicted, this seal 33 comprises, starting from the stationary support 2 and working radially toward the rotating support 3:

a static sealing heel 36;

an annular band 37 covering the wall 31; and

two dynamic sealing lips 38, 39.

The annular cover band 37 may be absent in certain embodiments. In other embodiments, not depicted, this seal 33 comprises, starting from the stationary support 2 and working radially toward the rotating support 3, just two dynamic sealing lips. The sealing lip 38, placed approximately in the continuation of the wall 31 and inclined slightly with respect to the latter, bears against the exterior lateral face 40 of the rotating support 3. The sealing lip 39 articulated about a hinge 41 bears with interference in the groove 22 against the faces 23, 24 of the base piece of the moving armature 5. Thus, the dynamic sealing lip 39 is preloaded, in one embodiment.

The geometry of the dynamic sealing lips 38, 39 means that the space separating the exterior face 27 of the encoder 6 and the stationary armature 4 is separated from the exterior surroundings ex by two compartments:

a first compartment 42 bounded by the contact 43 between the lips 38 and the rotating support 3, on the one hand, and the contact 44 between the lip 39 and the surface 23 of the bearing surface 8, on the other hand; and

a second compartment 45, bounded by the contact 44 defined hereinabove, on the one hand, and the contact 46 between the lip 39 and the surface 24 of the wall 12, on the other hand.

These two grease-filled compartments can act as a lock chamber that restricts the ingress of contaminants to the interior of the bearing. The seal 33 may or may not be solid and is made of an elastomer such as VITON, acrylonitrile or any other equivalent material, chosen according to the application.

Details of the magnetization of the encoder 6 will now be given. As can be seen in FIG. 1 or 2, the preassembled assembly 1 forming a seal with built-in encoder, intended to be mounted between a stationary support 2 and a rotating support 3 forming part of a rolling bearing or of a bearing has no means for directly mounting a sensor opposite the encoder. This is so as not to have to design as many sensor fixing means geometries as there are geometries of associated bearings.

Furthermore, in the set-up according to the invention, it is not necessary for the sensor to be placed in contact with the exterior lateral face 10 of the stationary armature 4. This is in order to prevent any impact or mechanical stress on the sensor associated with thermal expansion or with vibration and parasitic mechanical displacements, particularly the lateral parasitic displacements of the rolling bearing in its housing. For all of these reasons, the sensor has not been depicted in the figures because its position is not a fixed one.

The materials of which the stationary protective armature 4 is made are chosen to be nonmagnetic so as to allow the pulses emitted by the sensor 6 to be read through the stationary armature 4. The mechanical dissociation of the sensor with respect to the preassembled assembly 1 and the absence of contact between this sensor and the stationary protective armature 4 through which the magnetic flux of the encoder 6 is detected, admittedly do afford the sensor that protection and allow the assemblies 1 and the sensors to be designed independently. However, the person skilled in the art then, by definition, loses control over the size of the air gap.

The person skilled in the art actually knows that inductance decreases greatly when the air gap increases and that a threshold value of magnetic flux density governs the switching of a Hall sensor or magneto resistor sensor for an air gap of a given maximum value. The invention makes it possible to solve this technical problem while at the same time maintaining good resolution for the signal delivered by the sensor activated by the encoder and at the same time allowing the following, in combination:

the fitting of a sensor of the magneto resistor or Hall-effect probe type with a large air gap value;

the separate design of the sensor and of the preassembled assembly 1, there being no need for any means of direct mechanical association of the sensor facing the assembly 1;

the reading of the pulses emanating from the encoder through a stationary armature, the stationary armature affording the encoder 6 protection against external attack; and

the possibility of distancing the sensor from the exterior lateral face of the stationary armature that protects the encoder 6.

After trials, the inventors noticed that for the geometry of preassembled assembly 1 as depicted in FIGS. 1 or 2, the reduction in the number of pairs of holes made it possible to solve the problems set out hereinabove, while maintaining the combination of advantages listed hereinabove. This result is obtained even when using a strontium ferrite filled elastomer for the encoder, that is to say even using a material which nevertheless has only a low value of magnetic flux density per unit volume, by comparison with other materials such as neodymium-iron-boron alloys.

To reduce the number of pairs of poles is an unnatural step to be taken by a person skilled in the art who is well aware that the level of resolution of the encoder is poorer, the lower the number the pairs of poles. The resolution is often dictated by the application, for example those associated with the motor industry. By way of example, ABS applications give rise to a resolution, which is conventionally equal to 48 pulses per revolution.

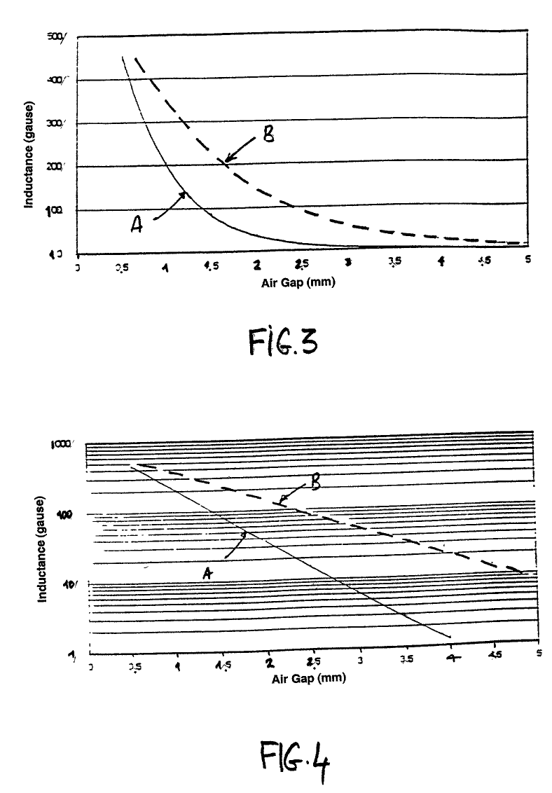

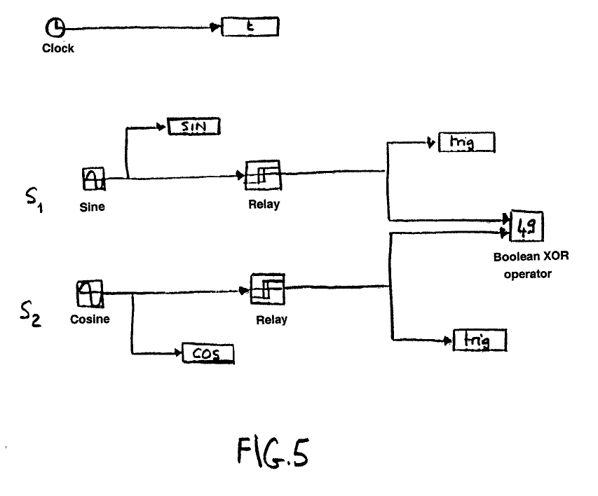

The variations in inductance observed as a function of the air gap are illustrated by way of indicative examples in FIGS. 3 and 4, for a geometry of the type depicted in FIG. 2. The curve A in solid line corresponds to a geometry of the type depicted in FIG. 2, for 48 pairs of poles, the number needed to allow a sensor with just one sensitive element to deliver 48 pulses per revolution. The curve B shown in dashed line in FIGS. 3 and 4 corresponds to a geometry of a preassembled assembly 1 identical to that associated with the curve A, except that the number of pairs of poles of the encoder 6 has been changed to a value of 24, giving rise to 24 pulses per revolution.

As is apparent from FIGS. 3 and 4, the value of the air gap, for a given value of inductance, varies greatly when the number of pairs of poles varies. Thus, for an inductance of 10G, for example, demanded for switching Hall-effect sensors, the air gap varies from 2.7 to 4.8 mm approximately.

The processing of the signal emanating from the encoder and received by a sensor of the magneto resistor or Hall-effect sensor type is now described. Dividing the number of pairs of poles by 2, by comparison with a conventional geometry, to culminate in 24 or even 12 pairs of poles entails signal processing so as to maintain an identical signal quality for the signal delivered by the sensor activated by the encoder 6. To do this, an electronic circuit may be associated with the sensor, the latter incorporating not one, but two, sensitive elements. When the distance between the sensitive elements is tailored to the multi-pole encoder, that is to say when the sensitive elements are separated by half the encoder pole pitch, a simple device using two triggers and an XOR (exclusive OR) function allows the resolution of the multi-pole encoder to be doubled.

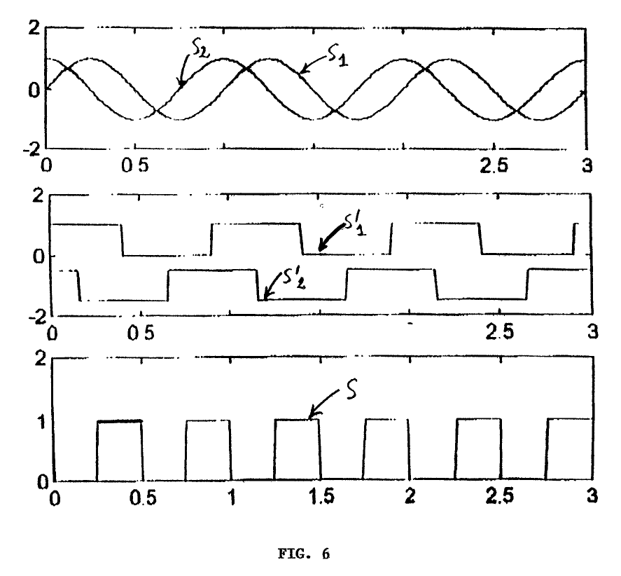

A block diagram of the processing operations is given at FIG. 5. The signals S₁, S₂ emanating from the elements are practically sine and cosine. Each of these signals is triggered about the 0 by passing, for example, through a triggering circuit in which the amplitude of the output signal has an abrupt and substantial variation in amplitude for a small increase in the input signal from a zero value. The digital signals thus obtained are phase-shifted by 90, electrically speaking, and have a resolution equal to the resolution of the multi-pole encoder. A boolean XOR (exclusive OR) function 49 allows the resolution of the output signal to be multiplied by 2.

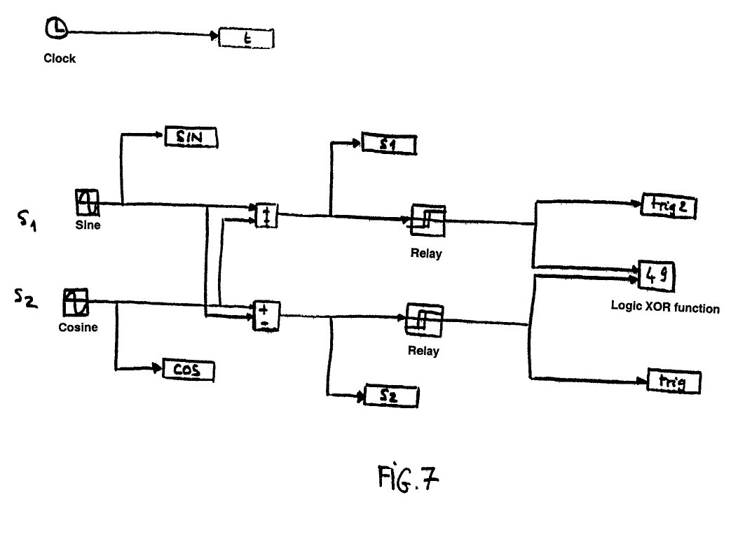

FIG. 6 diagrammatically shows the analogue signals S₂, S₁ exiting the sensor and the digital signals S₁′, S₂′ and the final signal S after passage through the XOR function 49. Thus, an encoder with 24 pairs of poles used in conjunction with such a sensor and such a processing circuit is able to obtain 48 pulses per revolution. When the distance between the sensitive elements is not tailored to the polar length, that is to say when the sensitive elements are not separated by half the pole pitch, but by a different amount, the signals emanating from the two sensitive elements are not longer phase shifted by 90° , electrically speaking.

Depending on the polar length of the encoder used, the phase shift is either greater than or less than 90° , and this has an influence on the duty cycle of the output signal. To cancel this effect, use may be made of a circuit such as the one depicted in FIG. 7 for converting the signals to a quadrature phase difference. The two input signals S₁, S₂ are replaced by their sum and their difference. As the signals obtained are in phase quadrature, the same processing as was explained hereinabove for the scenario in which the sensitive elements are shifted by half a pole pitch can be performed.

The use of this technique of multiplying the resolution of the encoder makes it possible to use one and the same sensor for all encoders regardless of the polar length.

Having described the invention, what is claimed is:

1. An assembly forming a seal with a built-in multi-pole magnetic encoder, intended to be mounted between a stationary support and a rotating support forming part of a rolling bearing, the assembly comprising:
a stationary armature secured to a stationary support; and
a moving armature bearing the encoder and secured to the rotating support;
the assembly being capable of having no means allowing the association of a sensor past which the encoder can move;
wherein the multi-pole magnetic encoder comprises a low even number of poles to allow an exterior lateral face of the stationary armature to be distanced from the sensor such that magnetic flux of the encoder may be detected by the sensor through the stationary armature.

2. An assembly according to claim 1, further comprising a seal secured to the stationary armature, the seal comprising at least one dynamic means such as a lip rubbing against the rotating support, the seal having no static sealing heel.

3. An assembly according to claim 1, further comprising a seal that covers an exterior lateral face of a seal support wall of the stationary armature, the seal comprising a static sealing heel in contact with an upper exterior lateral wall of the stationary support, and at least one dynamic sealing means running against the rotating support.

4. An assembly according to claim 1, wherein the moving armature comprises a first wall and a third wall which is offset axially toward the exterior with respect to the first wall, the first wall being connected via a connection fillet to a first cylindrical surface by which the moving armature bears against the moving support, the third wall bearing the magnetic encoder.

5. An assembly according to claim 4, wherein the moving armature comprises a base piece that has a cutout forming a fourth radial annular wall, offset toward the exterior, coated in the material of which the magnetic encoder is made.

6. An assembly according to claim 1, wherein a first annular wall and a second annular wall of the moving armature form an annular groove with an opening facing toward the exterior.

7. An assembly according to claim 6, wherein the annular groove in axial section exhibits a U-shaped or pseudo-U-shaped or V-shaped or pseudo-V-shaped profile.

8. An assembly according to claim 7, wherein the exterior lateral face of the groove comprises bearing surfaces for at least one dynamic sealing lip.

9. An assembly according to claim 1, wherein the encoder comprises a disk made of an elastomer filled with strontium ferrite or with barium ferrite.

10. An assembly according to claim 1, having a seal comprising, starting from the stationary support and working toward the rotating support: a static sealing heel; an annular band; and at least one dynamic seal lip.

11. An assembly according to claim 10, wherein a dynamic sealing lip bears against an exterior lateral face of the rotating support.

12. An assembly according to claim 1, in combination with a sealed rolling bearing comprising a stationary support or ring and a rotating support or ring.

13. An assembly in combination with a rolling bearing according to claim 12, wherein an exterior lateral surface of the stationary armature is offset toward the interior with respect to a plane tangential to exterior lateral faces of the bearing support or ring.

14. An assembly in combination with a rolling bearing according to claim 12, wherein an exterior lateral surface of the stationary armature is practically contained in a plane tangential to the exterior lateral faces of the bearing supports or rings.

15. An assembly in combination with a rolling bearing according to claim 12, further comprising a sensor of the magneto resistor or Hall-effect probe type, characterized in that with the number of pairs of poles fixed at the lowest possible value N for a given air gap, an electronic circuit coupled to the sensor maintains a signal quality identical to the quality that could have been obtained with an encoder comprising a number of pairs of poles equal to 2N.
